(19) United States
(12) Patent Application Publication
(10) Pub. No.: US 2024/0266647 A1
(43) Pub. Date: Aug. 8, 2024

(54) Containment for Energy Storage Devices

(71) Applicant: FOGTEC Brandschutz GmbH, Köln (DE)

(72) Inventor: Dirk K. Sprakel, Köln (DE)

(21) Appl. No.: 18/290,694

(22) PCT Filed: Oct. 29, 2021
(86) PCT No.: PCT/EP2021/080157

§ 371 Date: Jan. 19, 2024

(30) Foreign Application Priority Data
Jul. 21, 2021 (DE) 10 2021 118 862.8

(51) Int. Cl. H01M 50/143; H01M 10/48; H01M 10/613; H01M 10/625; H01M 10/6567; H01M 10/658; H01M 50/117; H01M 50/249; H01M 50/325; H01M 50/383

(52) U.S. Cl. CPC H01M 50/143; H01M 10/488; H01M 10/613; H01M 10/625; H01M 10/6567; H01M 10/658; H01M 50/117; H01M 50/249; H01M 50/325; H01M 50/383; H01M 2200/10; H01M 2200/20; H01M 2220/20

(57) ABSTRACT

A containment for an energy storage device comprising a container, a mounting for an energy storage device, a connection socket and connection duct, and an exhaust duct. The containment can be used to permanently extinguish the energy storage device in the event of a fault without endangering the environment.

The subject matter relates to a containment for energy storage devices, in particular accumulators, and a method for operating such a containment.

A variety of technical areas are currently undergoing progressive electrification. This applies above all to electromobility, but also to the energy supply of households, production facilities and many other areas. It is often necessary to temporarily store currently available electrical power in energy storage systems for later use. This applies in particular to applications in which a continuous power supply via the electrical distribution grid is not possible. For example, electric vehicles such as cars, ships or airplanes must be able to draw sufficient energy from an energy storage system during their journey. However, energy storage systems are also increasingly being used in stationary applications, for example in domestic grids, where energy generated from renewable energy sources is stored for later retrieval.

Energy storage systems convert electrical energy into potential energy in a variety of ways. Chemical energy storage systems, in particular accumulators, are widely used. These include, for example, lead, sodium-nickel chloride, nickel-metal hybrid and lithium-ion accumulators. Other energy storage systems such as hydrogen tanks in combination with fuel cells are also known. Potential energy can also be stored in mechanical form, for example in pumped storage power plants. However, these are not used in vehicles or households due to their low energy density and lack of transportability.

A common disadvantage of many of these energy storage systems is their potential for destruction in the event of a fault. This is because the energy stored in them might be released in an uncontrolled manner instead of being converted into electrical power in a controlled manner. This often leads to the release of a large amount of thermal energy. This thermal energy can be so enormous that parts of the energy storage unit and ultimately parts of its surroundings catch fire. The emission of hot gases and intense heat is not uncommon in this case.

Although the risk of ignition of energy storage devices, in particular chemical energy storage devices, especially accumulators, is not unknown, the countermeasures used to date do not take sufficient account of this risk. Reports of ignited accumulators and subsequently burnt-out electric vehicles such as passenger cars, transport vehicles, forklift trucks and ships are not uncommon. In most cases, a superficial extinguishing of an energy storage system cannot achieve lasting fire suppression and/or extinguishing.

Even weeks after apparently successful extinguishing, energy storage systems can ignite again on their own. Accumulator fires are characterized by the rapid emission of large quantities of toxic and corrosive gases at extremely high temperatures and the occurrence of high-energy flames in the form of jet flames over a long period of time.

This results in the object of minimizing the damage that can be caused by an energy storage system in the event of a fault and, in particular, protecting people in the immediate vicinity from heat and toxic gases.

The object is solved by a containment for an energy storage device according to claim 1 and a method according to claim 28.

For this purpose, the containment comprises a container.

The container can be any type of at least partially closed housing. Outer walls of the container delimit it from its surroundings. The outer walls need not completely enclose the interior of the container but may have openings. For example, the container can have a base and side walls, while an upper part can remain open. The container can also be essentially completely closed, in particular closed in a pressure/gas and/or fluid-tight manner. In particular, the container can be completely closed and at the same time have defined inlets and outlets. The container can be multi-part, so that, for example, a base body with one or more openings and closure parts for the at least one opening are provided. For example, one or more closures can be provided. The container may, for example, have a substantially rectangular, round, oval, triangular or polygonal cross-section.

The container can be sealable. For example, one or more openings of the container can be closed with one or more closures. Closing an opening can mean simply sealing it so that fluids can no longer pass through the opening. Closing can also mean locking, for example with a lock, which prevents unauthorized persons from accessing the interior of the container through the lockable opening. A closure can be a lid, for example. Locks can be detachable from the container. Locks can also be attached to the container, in particular movable, and in particular captive. For example, a closure can be attached to the container with hinges. It is also possible, for example, for a closure to be guided on rails arranged on the container.

A closure can be closed and opened manually. It is also possible that an actuator such as a motor, a servomotor, an electromagnet, gas or another actuator is set up to close and/or open a closure. The closure can be closed and/or opened via an electrical signal or a thermally reacting element.

A closure can close the respective opening partially or substantially tightly, in particular pressure/gas and/or fluid-tight.

The container can also have fastening means. The fastening means can be arranged on the outside of the container and can, for example, be shaped as recesses for a screw connection. The fastening means allow the container to be arranged in a fixed position and remain permanently fixed in relation to its surroundings.

The container can also have spacers to ensure that its outer wall does not come into direct contact with other elements in the environment. These can be feet in the floor area, for example, or protrusions on the sides and also on the top of the container roof. In particular, spacers can be made of material with particularly poor thermal conductivity in order to achieve a good insulating effect. A spacer can also comprise a further, outer wall of the container, which is spaced from the first, inner container wall.

The container has a mounting for one or more energy storage units. The purpose of the mounting can be to hold the energy storage device(s). For example, the mounting may comprise a frame into which an energy storage device, for example a chemical energy storage device such as an accumulator, can be inserted.

The mounting can also include fastening means for the energy storage device. For example, clamps, rails, straps, Velcro fasteners, adhesives or other fastening means can be provided, which can fix the energy storage device temporarily or permanently in the mounting.

The mounting can comprise a wall. The wall can be divided into an inner and an outer wall. The wall can be formed in one piece or in several pieces. The wall can be made from one material or from different materials. For example, the inner wall of the mounting can be made from a first material and the outer wall from a second material. For example, at least parts of the wall, in particular the inner wall, can be formed from a heat- and/or fire-resistant material, in particular metal, a mineral material such as stone or concrete, glass, ceramic, heat- and/or fire-resistant plastic or similar materials. At least parts of the wall of the mounting can delimit the mounting with respect to the interior of the container.

The mounting can be open to the interior of the container. It is also possible for the mounting to be closed off from the interior of the container, in particular at least partially by means of the wall of the mounting. In particular, the mounting can be pressure-tight, gas-tight and/or fluid-tight with respect to its surroundings, in particular with respect to the interior of the container.

The mounting can be arranged in the container in such a way that a gap remains between the energy storage device and at least parts of the inner walls of the container.

Several mountings for energy storage devices can also be arranged in one container.

The containment also comprises a connection duct. This can comprise a pipe, a hose, a duct or a similar element that is suitable for guiding a fluid. In particular, the connection duct leads to the at least one mounting for an energy storage device. The connection duct is particularly suitable for carrying a fluid, especially water. For this purpose, the connection duct can be designed to be essentially fluid-tight. At least a first opening of the connection duct can be provided in the inner volume of the container, in particular in the area of the mounting, and a second opening, which is located at least partially outside the mounting and/or the container. For example, the second opening of the connection duct can be located in the area of the outer wall of the container. The second opening can also be located in the area of the wall of the mounting.

At the connection duct, in particular at the second opening of the connection duct, a connection socket is provided. A fluid-conducting element, for example a hose, a pipe, a tank or a similar element, can be connected to the connection socket. For example, a fluid supply such as a water pipe can be connected to the connection socket, in particular connected in a fluid-tight manner, for example indirectly via a fluid-conducting element. In particular, an existing fluid supply that is not primarily used for firefighting can be used. For example, a domestic water connection, utility water connection, water from the sea, lakes and/or rivers, the cooling fluid of a cooling system and many other existing fluid supplies can be connected to the containment in question easily and without any necessary adaptations via the connection socket. The connection socket can, for example, have a thread via which a fluid-conducting element and/or a fluid supply can be connected in a fluid-tight manner. A fluid-conducting element can also be connected to the connection socket in a force-fit, for example plugged or form-fit, for example by means of one or more hooks, in particular in a fluid-tight manner, so that no fluid escapes unintentionally from the connection socket and/or its connection to a fluid-conducting element. In particular, a fluid-conducting element can be permanently connected to the connection socket. In this way, it is possible to provide a flow of fluid into the containment at all times and safety is maximized. A temporary connection is also possible, for example with a quick coupling. In this way, flooding can be made possible if required. For example, a seal can be provided on the connection socket.

In particular, existing fluid supplies can be used for the operation of the containment.

A fluid can be a liquid, and a fluid can also be a gas. In particular, fluids can be aqueous, especially water, for example tapped water, distilled water, a suspension, aqueous solutions and/or an oil, a foam, and many other liquid forms of fluids. A gaseous fluid can, for example, comprise a gas such as nitrogen, CO2, argon, a mixture of these or other, preferably slow to react and/or inert gases, which can also be referred to as extinguishing gases.

Fluid-conducting elements can be open or closed. Open means that a fluid can flow through the respective element. Closed means that no fluid can flow through the respective element. For example, a valve can switch between an open and a closed state, for example thermally, electrically and/or manually controlled. Opening or closing can also be realized by an automatic or manual pump.

The connection socket and/or connection duct can be opened and closed. In particular, the connection socket can have a valve. This can be operated manually and/or by an actuator, for example by motor.

Furthermore, an exhaust socket is provided as part of the containment. In particular, this can be connected to the mounting. A connection between the mounting and/or the interior of the container and the surroundings of the container can be established via the exhaust socket. For example, air, steam or smoke, in particular fire gases, can be conducted through the exhaust socket, in particular discharged from the mounting/container. In particular, the exhaust socket can be located in the upper area of the container and/or the mounting. An internal exhaust duct can be arranged on the exhaust socket, which leads from the mounting to the exhaust socket inside the container. This inner exhaust duct can also be part of the exhaust socket. In addition, an external exhaust duct can be provided, for example a chimney, a pipe, a shaft or another duct which is particularly suitable for conveying gaseous volumes, especially hot, vapor-saturated and/or contaminated gaseous volumes. In particular, the exhaust duct can lead volumes out of the immediate vicinity of the containment. For example, if the containment is installed in a room, the exhaust duct can be used to guide volumes out of the room. In this way, it can be ensured that the immediate vicinity of the containment remains safe, in particular that it is not overheated and/or exposed to toxic or otherwise hazardous emissions. In this way, objects in the vicinity of the containment are protected and it remains safe for people to be in the immediate vicinity.

In one embodiment, the exhaust duct can comprise a flame trap, in particular in the area where the end of the exhaust duct faces away from the container and/or the mounting.

In one embodiment, the exhaust duct can also be opened directly into the room surrounding the containment, which can be called the installation room. In order to protect the installation room from hot gases, flames and/or other harmful influences, a so-called flame trap can be used, at least among other things.

In particular, the flame trap can comprise a pipe section that changes its orientation several times. For example, the flame trap can comprise a pipe section that is at least partially bent in a sinusoidal, zigzag, spiral and/or other shape. For example, the flame trap can change its orientation at least twice, three times, four times, five times and/or more often, in particular at so-called changes of direction. A change in direction can refer to a pipe section with, for example, a change in pipe orientation by at least 20°, 30°, 40°, 50°, 70°, 90° and/or by a higher angle. The change in direction can, in particular, extend to a pipe section with a length of, for example, at most half, one, two, three and/or another multiple of the pipe diameter. For example, an essentially straight piece of pipe can be arranged between at least two of the changes in direction of the flame trap.

By means of the flame trap, the propagation of flames through the exhaust duct in the area of the flame trap can be at least partially and/or largely and/or completely prevented.

As an alternative and/or in addition to the flame trap, a diffuser can be provided at the end of the exhaust duct, in particular starting from the container and/or the mounting behind the flame trap. A diffuser can be characterized, for example, by a cross-section that increases in the direction of flow of the exhaust air. For example, the diffuser can be shaped like a funnel.

The exhaust duct can have a siphon. In particular, the siphon can be a part of the exhaust duct filled with a fluid. For example, the exhaust duct can have a passage from which the course of the exhaust duct is aligned against gravity in both directions of the exhaust duct. The siphon can therefore form a local minimum in the height of the exhaust duct. A fluid can be stored in the siphon, which in particular occupies the entire cross-section of the exhaust duct. This ensures that volumes that are discharged through the exhaust duct are guided through the fluid. The fluid can, for example, cool and/or clean the volumes, such as smoke, steam, toxic gases and other volumes conducted through the exhaust duct, thus making the discharge from the exhaust duct less dangerous for people, technology and the environment.

In particular, the siphon can have a siphon drain for fluids, via which the fluid contained therein can be drained. The drain can be realized via a siphon drain socket in the exhaust duct. This can be fitted in the wall bounding the exhaust duct, in particular in a fluid-tight manner. The siphon drain can, for example, lead into a collection volume, such as a collection tank, a balloon and/or another collection volume, which can in particular also be used to collect fluid from the inside of the container. The siphon outlet can limit the filling height of the siphon by lowering its outlet to the desired filling height. For example, the siphon drain can have a local maximum at the desired fill level of the siphon. If the fluid level in the siphon exceeds the desired fill level, the fluid is thus discharged via the siphon outlet.

The siphon can also have a siphon inlet via which the siphon can be flooded with fluid. In particular, the fluid in the siphon may partially vaporize and/or be driven out of the siphon by a strong flow of volumes in the event of strong heat, which is discharged via the exhaust duct. A siphon inlet can refill the siphon with fluid. In particular, the siphon inlet can have a valve, especially a non-return valve. The valve can regulate the flow of fluid into the siphon and/or prevent the return flow from the siphon into the fluid-conducting elements connected to the siphon inlet.

In one embodiment, further fire protection devices such as, in particular, valves, spray nozzles, fire extinguishers and/or similar fire protection devices can be provided in the direct vicinity of the containment. These can be activated in particular when the containment activates a measure for fighting the fire of the energy storage device, in particular when the fluid inlet into the containment is activated.

In one embodiment, the exhaust socket/duct can at least partially serve to discharge liquid fluid. For example, the exhaust socket can be permanently open or can also be closed and open. The liquid fluid can, in particular when the container and/or the mounting are largely filled and fluid continues to be supplied through the connection socket, be discharged via the exhaust socket. In particular, an outlet for liquid fluids and an outlet for gaseous fluids can be provided in the exhaust socket. For example, the siphon outlet can be used to transport liquid fluid out of the exhaust duct. The siphon can therefore perform a dual function. On the one hand, it cools and cleans the discharged gaseous fluids. Secondly, it separates gaseous and liquid fluids in the exhaust duct. If liquid fluid is transported through the exhaust socket, the siphon inlet can also be omitted, as liquid fluid is fed directly from the container and/or the mounting into the discharge duct anyway.

The container and/or the mounting can be flooded and/or flowed through, in particular with a fluid. In particular, the direct surroundings of an energy storage device, which is located at least partially within the mounting and/or the container, can be flooded and/or flowed through. The energy store can be cooled in this way.

The exhaust socket, inner and/or outer exhaust duct can be at least partially made of a heat-resistant and/or fireproof material. For example, made of metal, a mineral material such as concrete or stone, glass, ceramic, heat-resistant plastic or similar materials. The shape of at least one of these elements can also be designed in such a way that volumes that are hot, steam-saturated and/or contaminated can be transported through them. This can be ensured in particular by a sufficiently high internal cross-section, for example of at least 1 cm², 5 cm², 10 cm², 50 cm², 100 cm². A round or oval cross-section is advantageous for minimizing the inner surface on which deposits can form. The straightest possible course of the exhaust socket, the inner and/or outer exhaust duct can also increase the suitability of these elements for transporting such gases. For example, bending radii of these elements can always be at least 10 cm, 20 cm, 50 cm, 100 cm or 200 cm. An exhaust duct can be dimensioned according to the DIN EN 13384 standard, for example.

The exhaust socket can be permanently open. In this case, it is advisable to install the exhaust socket in an upper area of the mounting/container.

In one embodiment, the exhaust socket is sealed fluid-tight against the mounting with a closure. In this context, fluid-tight can denote a seal against solids and liquids, but not against gases, as well as a seal against solids, liquids and gases. The closure prevents the exchange of gases and/or liquids between the interior of the container and/or the mounting and the environment of the container and/or the mounting. In particular, the closure can be opened. For example, the closure can open as a function of a pressure and/or a temperature in the mounting and/or in the container. An example of a closure can be a float valve, which prevents the flow of fluid into the exhaust duct. For example, the closure can be thermally activated, in particular as a bursting disk. The shutter, in particular the rupture disk, can also be activated by pressure. In particular, the closure can be closed for pressures in the container and/or the mounting below a given threshold value. If the pressure in the container and/or the mounting exceeds the threshold value, the closure, in particular the rupture disk, can open. Other closures are also possible, such as valves, non-return valves, diaphragms that only allow gas to pass through, or a spring that is held by a glass barrel, a bimetal or other closures.

In one embodiment, the exhaust socket can be designed to remove heat, smoke, steam and/or gas from the container. In particular in the case of a heated energy storage device, pressure and/or an increased temperature can develop inside the mounting and/or the container. The exhaust socket in question can be used to reduce the pressure and/or temperature in the mounting and/or container by enabling gas exchange with the environment. In addition to pressure and temperature, energy storage units can also release smoke, gases, especially toxic gases, and steam. An exhaust socket enables the controlled removal of these substances, some of which are harmful to health and/or other technical equipment. As an exhaust socket and/or the exhaust duct can become very hot, heat protection can be provided for ducts, especially through walls, in particular through walls of a building and/or vehicle such as a boat, a car or similar. For example, a metal plate, insulating material such as rock wool or other heat-resistant feedthroughs and/or containments can be provided as a feedthrough. Active cooling can also be realized, for example by means of a device that applies a fluid to the exhaust socket and/or the exhaust duct, for example by spraying it, allowing it to flow onto it or transporting it there in some other way.

In particular, the effects of any heating, fire and/or explosion of an energy storage device inside the containment outside the containment and/or outside the room in which the containment is installed can be minimized and/or essentially avoided by means of an exhaust socket.

In one embodiment example, a cable entry for one or more electrical cables is provided in the outer wall of the container and/or the wall of the mounting. A cable routed through the cable entry can, for example, be used for the electrical connection of an energy storage device in the container and/or in the mounting with technical equipment located outside the container and/or the mounting. In an advantageous embodiment, the cable entry is fireproof. Cables, in particular cable insulation, can ignite or at least smoulder under certain circumstances. To prevent heat and/or fire inside the container and/or the mounting from being transmitted via the cable entry, it is advantageous if the cable entry is fireproof. This can be achieved by selecting the insulating material, among other things. For example, metal conductors can be encased directly in mineral materials such as concrete and/or stone, ceramics, glass and/or generally heat-resistant and flame-retardant materials.

The cable entry can also be designed to be pressure-resistant. This has the advantage that even in the event of overpressure in the container and/or the mounting, the pressure is only released via the exhaust socket, but not via the cable entry. In particular, it can be advantageous if the cable entry is designed to be fluid-tight, especially gas- and/or liquid-tight. This ensures that gases and liquids inside the container and/or the mounting cannot escape via the cable entry. A pressure/gas and/or fluid-tight design can be achieved using a rubber seal, for example. It is also possible, for example, for the cable entry and the outer wall of the container and/or the wall of the mounting to be made in one piece.

An energy storage unit can be arranged in the mounting. In particular, this can be an electrical energy storage device, especially a chemical energy storage device, in particular an accumulator. An accumulator can be, for example, a lead, sodium-nickel chloride, nickel-metal hybrid and lithium-ion accumulator. Other types of energy storage devices are also possible, for example a gasoline, hydrogen or other fuel tank.

Parts of the containment, in particular the mounting and/or the container, can be made at least partially of heat-resistant, fire-resistant and/or chemically resistant material. Such a material can, for example, be a metal, in particular steel, stainless steel or fireproof steel. Fire-resistant plastics such as Teflon or, in some applications, PET, PETG, polycarbonate and PVC are also possible. Ceramics are also a suitable material with high heat resistance and good electrical insulation properties. The latter can ensure further protection of the environment, especially in electrical energy storage systems. Mineral materials such as stone, concrete and/or masonry are also possible, as are glass or ceramics. Parts of the container and/or the mounting can in particular comprise masonry and/or concrete. For example, at least part of the container may be bounded by walls that form at least part of the outer walls of the container. For example, the container may be partially shaped as a basement room of a building.

In one embodiment example, the container and/or the mounting can be closed in a pressure-resistant manner. In particular, only the container can be pressure-tightly sealable, but not the mounting, or conversely, only the mounting can be pressure-tightly sealable, but not the container. Preferably, in the event of overpressure, the exhaust socket is the only option for pressure equalization. To ensure pressure resistance, all access points to the interior of the container and/or to the mounting must be pressure-resistant.

In particular, the connection duct can be designed to be pressure-resistant. For this purpose, a non-return valve, for example in the form of a backflow preventer, can be provided in the connection duct and/or connection socket, which can prevent fluid transport out of the container and/or the mounting. A good seal must also be ensured around the connection duct to ensure pressure resistance. This prevents volume from escaping from the container and/or the mounting in the vicinity of the connection duct, more precisely in the transition between the connection duct/socket and the outer wall of the container and/or a wall of the mounting.

As already explained above, similar sealing measures to those for the connection duct/socket should also be taken for the cable entry.

All other openings, for example openings to reach the interior, for example to insert the energy storage unit, or other (cable) feed-throughs, drainage, connection, exhaust sockets and the like, of the container and/or the mounting can be sealed in a pressure-tight manner. Closures can be provided for this purpose, which can be applied to openings in a fluid-tight and/or pressure-tight manner, for example. For example, threads can be arranged on openings of the container and/or the mounting. Lids, also equipped with a thread, can be screwed onto these, for example. Other methods of sealing are also conceivable, for example screw connections with several screws per seal, clamps, latches, electromagnets or other closure means. A seal can be electronically controllable, for example by means of a motor. In order to achieve a pressure-tight seal, it is also recommended that circumferential seals are arranged on an opening of the container/mounting and/or on the associated seal, which preferably enclose the opening circumferentially.

In one embodiment, in addition to a connection socket, for example for a fluid supply, a drain socket can also be provided. A drain duct can also be connected to the drain socket, which extends from the drain socket into the container and/or to and/or into the mounting.

The drain socket can be arranged in the outer wall of the container. The drain socket can also be arranged in the wall of the mounting. Similar to the socket, the drain socket can be connected to a further fluid-conducting element, for example outside the mounting and/or outside the container, for example in a force-fit or form-fit manner, for example by means of a thread, which is arranged on the drain socket, for example.

Fluid, in particular a liquid, in particular water, can be discharged from the container and/or the mounting via the drain duct and drain socket. For this purpose, a fluid-conducting and, in particular, fluid-tight connection is provided at least indirectly to a target volume such as, for example, at least a part of the sewer system, a wastewater, a body of water, a collection tank, a balloon, in particular an elastic balloon, and/or to similar target volumes. Since fluid, in particular water, that has been in direct contact with a damaged energy store may be chemically contaminated, it may be advisable for the target volume to be closed, for example as a collection tank.

The drain can be equipped with a seal. In particular, a non-return valve can be arranged in or on the drain to prevent backflow into the container. An adjustable seal can also be provided. For example, a valve can close and/or keep open the drain, in particular the drain socket and/or the drain duct. The valve can be operated manually, for example. It is also possible to control the valve using an actuator, such as a motor.

The fluid-tightness of the connection between the drain socket and the target volume (e.g. a collection tank) can be realized as described above by a corresponding connection between the drain socket and an adjoining fluid-conducting element, such as a duct, a pipe, a hose or similar. For example, a screw cap can be provided on the drain socket and/or a force-fit, form-fit or other closure. Optionally, a seal is provided on the drain socket.

In one embodiment, the drain socket is arranged in a lower area of the container and/or the mounting. This allows the container and/or the mounting to be emptied to a large extent, in particular almost completely.

In one embodiment, the connection socket is arranged in an upper area of the container and/or the mounting. In particular in combination with a drain socket in a lower area of the container and/or the mounting, it is thus achieved that in the case of a combined inflow and outflow of fluid, the fluid is exchanged as extensively as possible and as few parts as possible of the internal volume of the mounting and/or container only achieve a small fluid exchange. Fluid exchange due to thermal mixing can also be achieved by warm fluid volumes rising.

Connection and drain sockets can also be located at essentially opposite positions of the container and/or mounting so that there is the greatest possible distance between them, for example at diagonally opposite positions. This also maximizes the exchange of fluid.

In this case, the upper area is located above the lower area in the direction of gravity when the container and/or mounting is in the upright position.

In one embodiment, at least one distribution means is located in the container and/or the mounting. This can be in fluid connection with the connection duct. The distribution means can serve to distribute fluid flowing via the connection duct into the container and/or into the mounting in the mounting and/or in the container. For example, the distribution means may comprise fluid-conducting elements, such as one or more pipes, hoses or ducts embedded in the walls (inner walls or outer walls) of the container, or similar elements. The distribution means can have several outlets, for example holes, and in particular nozzles can be arranged in the outlets. The outlets can be arranged at several spaced-apart positions within the mounting and/or within the container. In this way, it can be ensured that the fluid flowing into the mounting and/or container is distributed as widely as possible. In one embodiment, the outlets of the distribution means are the only positions at which fluid can enter the container and/or the mounting from the socket.

In one embodiment, the connection socket and/or the drain socket are arranged on the container and/or the mounting in such a way that they cannot be lost. For example, the sockets can be screwed to the outer wall of the container, injection-molded, glued in or even formed in one piece with the outer wall of the container.

In one embodiment, a fluid supply can convey fluid into the container and/or the mounting via the connection socket and the connection duct. A fluid supply can comprise a pump. The pump can be motorized and/or manually operated, for example. The pump can pump fluid from a fluid volume towards the container, for example such a fluid volume can be a tank, it is also possible, if the fluid is water, to connect the pump to a fixed water supply for potable or process water, to groundwater or to an open body of water. In one embodiment, the containment is arranged on a floating vehicle. In this case, the pump can draw water directly from the body of water on which the floating vehicle is located. It is also possible for the fluid supply to be provided by the infrastructure on land. The fluid supply can be a water connection of a building, for example. There is no need for an additional pump if the water pipe is already under sufficient pressure.

The flow through the connection duct and/or connection socket can be adjustable with an actuator. For example, a valve can be provided in the connection duct/socket, in particular a manually and/or electrically/electronically controllable valve. The drain duct/socket can also be controlled in the same way. The flow through the connection duct/socket can also be adjusted by controlling a pump of the fluid supply.

In one embodiment, the connection and drain are coupled in such a way that an activated flow through the connection duct/socket causes the drain socket/duct to open and/or vice versa.

In one embodiment, in addition to a connection duct and any distribution means, at least one extinguishing device can be arranged in and/or on the container and/or the mounting. For example, this can be a powder, foam or CO2 fire extinguisher. It is also possible to supply an inert and/or chemically active gas such as nitrogen, CO2 and/or another extinguishing gas into the container and/or into the mounting. The extinguishing device can be designed to be controllable, for example by opening a valve to a gas reservoir or fire extinguisher.

In one embodiment, at least one sensor is arranged in and/or on the container and/or the mounting. In particular, a sensor can be a temperature sensor. Thus, the temperature inside the container and/or inside the mounting can be monitored and allows the detection of any critical temperature values and/or temperature curves and/or gases by means of a corresponding evaluation. A temperature sensor is advantageously located close to the energy storage unit in order to be able to map its temperature as accurately and unadulterated as possible. A gas sensor can detect dangerous gases, and in particular gases that indicate an impending fire, at an early stage. A pressure sensor can also be provided. This allows dangerous pressures to be detected. A fill level sensor is another option that can, for example, detect whether and/or to what degree the container and/or the mounting is filled with fluid. A humidity sensor and/or an optical sensor can also be provided to monitor the inside of the container and/or the mounting. A pH sensor can, for example, check whether acid from a chemical energy store has already penetrated into the fluid, in particular the water. A sound and/or vibration sensor can be used to detect any shocks and/or explosions. An acceleration sensor can be used to check the alignment of the container and/or the mounting, among other things.

In one embodiment, display means can also be arranged on the containment, in particular acoustic display means such as a loudspeaker, buzzer, siren or similar. Visual display means such as a light or a display can also be provided. A display means can also be implemented without an external power supply. In this way, increased reliability is achieved and at the same time the containment can be designed in a cost-effective manner. For example, pressure can be indicated by means of a pressure gauge that measures the internal pressure in the container and/or in the mounting, or a mechanical element, for example based on a spring, which visibly pushes out of the container when internal pressure is applied. For example, a compressed air horn can indicate the internal pressure. The temperature can, for example, be realized cost-effectively using a temperature-indicating paint, such as an indicator paint, a sticker with a temperature indicator function or similar. In this way, an operator of the containment can be warned of a heated state of the device, in particular of the temperature of the outer wall of the container. A thermally conductive connection in the interior of the container, such as a steel pin, can improve the precision of the indicator.

In a further embodiment, the containment can comprise a control device. This may, for example, be an electronic circuit, in particular an analog circuit, a digital circuit or a combination of the two. In one embodiment, the control device comprises a processor.

The control device can be arranged in or on the container. It is also possible to arrange the control device in or on the mounting. The advantage of an arrangement outside the container is a lower exposure of the control device to chemical and thermal stresses in the event of overheating and/or fire of the energy storage unit. An insulating layer between the outer wall of the container and the control unit can protect the latter from damage caused by excessive heat.

The control device can have its own power supply, which is in particular independent of the energy storage unit.

The control device can, for example, receive a measured variable from at least one sensor of the containment. For example, a microcontroller as a control device can receive an analog transmitted measured value from a sensor by means of an analog-digital converter. Measured values can also be received in other ways, for example digitally.

The control device can also be set up to control actuators of the containment. An actuator here can be, for example, a valve, such as a connection and/or drain, a pump, a motor, such as a servomotor, or another actuator. In this way, the control device can regulate the flow of fluid into and out of the container and/or the mounting, among other things. It is also possible for the container and/or the mounting to be opened and/or closed by means of the control device. An actuator can also be set up to trigger a further extinguishing device, for example to open a gas valve to admit nitrogen, CO2 and/or another extinguishing gas into the container and/or the mounting or to activate a fire extinguisher.

The control device can also control display means such as a loudspeaker and/or a light source. In particular in combination with receiving measured values from at least one sensor, detected dangerous operating states of the energy storage unit such as overheating and/or a fire can be displayed. Display means can have their own power supply or, for example, the power supply of the control device.

As already explained above, the connection socket and/or the drain socket and/or the fluid supply can be controllable, in particular as a function of a measured value detected by one and/or more of the sensors, in particular a fluid level and/or a temperature of the fluid in the container and/or the mounting, in particular by means of the control device. Valves, inlets, pumps and/or other actuators of the containment can be controlled on the basis of measured variables such as temperature, pressure, fill level and others.

In an advantageous embodiment, a volume of fluid discharged through the drain socket can essentially correspond to the volume that is fed through the connection socket. In this way, the fluid is exchanged without overfilling the containment. In particular, the interior of the container and/or the mounting can be filled via the connection socket until a desired fill level is reached. Drainage can then be enabled via the drain socket.

The combination of receiving sensor data and controlling actuators can enable effective control of dangerous operating conditions as well as one or more warnings and/or other automated measures. In particular, flooding of the container and/or the mounting via the connection duct can be triggered when a condition classified as critical has been reached. Continuous monitoring of the container and/or the mounting, in particular of gases, can ensure that the start is triggered in good time and the success of the measures can be monitored. For example, a temperature can be continuously measured and an inflow and outflow can be maintained until a target temperature is reached.

If appropriate actuators are present, the control device can also be used to close the container and/or the mounting. In particular, this can be done when a dangerous operating state is detected, especially a fire in the energy storage unit. This means that the energy storage unit can remain ventilated during non-critical operating states through an open opening of the container and/or the mounting. However, as soon as a critical operating state occurs, the energy storage unit can be sealed off from its surroundings. If the container and/or the mounting can be opened and/or closed, in particular can be reconfigured from an open state to a closed state, in particular by means of an actuator, in particular by means of a motor and/or a spring, for example a thermally triggering spring, this reconfiguration can be triggered in particular by the control device.

In one embodiment example, a fluid circuit can be provided on the containment. In particular, a fluid circuit can be a closed fluid circuit. In particular, the fluid circuit may have an inlet. For example, the fluid circuit can describe an internal volume. The internal volume of the fluid circuit may at least partially correspond to the internal volume of the container and/or the mounting. The internal volume of the fluid circuit may also be at least partially arranged outside the container and/or the mounting.

The fluid circuit can be at least partially filled with a fluid. The fluid circuit can also be substantially completely filled with a fluid. For example, the fluid circuit can be filled with a gas in a first state. The fluid circuit can be filled, in particular with a fluid, in particular through the inlet of the fluid circuit, in particular in such a way that a gas escapes from the interior of the fluid circuit.

The fluid circuit may comprise an exhaust duct. For example, the exhaust duct of the fluid circuit can allow a gas that is inside the fluid circuit to escape when the fluid circuit is filled. For example, the exhaust duct can only allow gases, in particular no liquids, to pass through. For this purpose, the exhaust duct can comprise a semi-permeable membrane, for example. Valves that only allow gases but no liquids to pass through are also possible, in particular valves with a float.

In particular, the fluid circuit can comprise a first duct leading from an outer area of the containment into an inner area of the container and/or the mounting. In addition, the fluid circuit can in particular have a second duct leading from the inner area of the container and/or the mounting. The first duct and the second duct may in particular be in direct and/or indirect fluid communication with each other outside the container and/or the mounting. The first duct and the second duct may additionally and/or alternatively be connected to one another inside the container and/or the mounting, in particular by means of the interior of the container and/or the mounting.

The fluid circuit, in particular its internal volume, can comprise a first part within the container and/or the mounting. The fluid circuit may comprise a second part, in particular different from the first part, which is located outside the container and/or the mounting.

The fluid circuit may comprise a drive. For example, a pump can be arranged in the fluid circuit. The drive can, for example, be arranged outside the container and/or the mounting. It is also possible to arrange the drive at least partially inside the container and/or the mounting. The drive, in particular the pump, can drive a fluid through the fluid circuit. In particular, the drive can propel a fluid within the fluid circuit from a first internal volume located outside the container and/or the mounting into an internal volume located inside the container and/or the mounting. The drive can also propel a fluid within the fluid circuit from a second internal volume located inside the container and/or the mounting into an internal volume located outside the container and/or the mounting.

The fluid circuit can, for example, include a heat exchanger. For example, the heat exchanger can be arranged outside the container and/or the mounting. The heat exchanger can, for example, comprise at least one fluid-conducting element that has a large outer surface area in relation to its internal volume. For example, the heat exchanger may comprise a flat tube, one and/or more thin tubes, an arrangement of two or more plates arranged parallel to each other and/or other arrangements with an internal volume and a large external surface area. Other common heat exchanger designs are also possible. A heat exchanger can, for example, comprise a further circuit in addition to the fluid circuit, such as a fluid-conducting circuit. For example, a counterflow heat exchanger and/or a co-current heat exchanger can be provided. The fluid in the fluid circuit can be cooled via the heat exchanger.

In this way, for example, a fluid in direct contact with an element located in the container and/or the mounting, such as an energy storage unit, can be guided along the fluid circuit. In a fluid circuit, particularly a closed fluid circuit, the possible soiling and/or contamination of the fluid is less critical than if the potentially contaminated fluid were to flow out of a drain socket into another volume. In particular, there is no need to provide a collection volume that may have to be able to hold large volumes of potentially contaminated fluid. Instead, the interior of the mounting and/or the container can release heat in direct contact with the fluid. This heat can be released outside the container and/or the mounting, for example via the heat exchanger.

In one embodiment, cooling can also be provided in the container and/or the mounting. In particular, for example, cooling pipes can be led into the container and/or into the mounting through a further feedthrough.

In one embodiment, the container and/or the mounting may comprise a cooling device. The cooling device can be set up to cool the fluid in the container and/or the mounting. The cooling device allows the fluid that comes into direct contact with the energy storage device to remain in the containment. In particular, it does not have to be replaced for cooling. This avoids the possibly contaminated fluid having to be discharged and the waste produced during extinguishing is reduced to a minimum.

The cooling device can, for example, be formed by the wall of the container and/or the wall of the mounting. In particular, the wall and/or wall can be at least partially double-walled. Thus, there may be at least partially an inner and an outer wall of the container and/or an inner and an outer wall of the mounting. There may be a space between the inner and outer walls and/or walls. In one embodiment, this intermediate space may also comprise a further connection socket for connection to a fluid-conducting element, in particular to a fluid supply. The intermediate space can also be in fluid connection with the connection socket of the container and/or the mounting. In the case of a separate connection socket for the intermediate space, it is possible in particular for different fluids to be fed into the intermediate space and into the container and/or into the mounting. The at least one intermediate space between the inner and outer wall of the container and/or the mounting can be filled with fluid. The fluid volume inside the container and/or the mounting is cooled by the inner wall without the fluid in the intermediate space and the fluid in the interior of the container and/or the mounting mixing with each other.

Instead of or in addition to a double-walled container wall and/or wall of the mounting, other fluid-conducting volumes can also be guided through the inner volume of the container and/or mounting. These can be cooling pipes, for example. These can also cool the potentially contaminated fluid in the interior of the container and/or the mounting.

A seal between the mounting and the inner volume of the container can also serve as a cooling device. The mounting can be flooded separately, for example with a separate connection duct and exhaust duct of the mounting. In addition, the inner volume of the container surrounding the mounting can be flooded. The two fluids, inside and outside the mounting, do not mix, but the fluid in the inner volume of the container can cool the fluid inside the mounting through the wall of the mounting.

By flooding the volume of the containment, in particular the interior of the container and/or the mounting, the advantage is that direct cooling of the energy storage device is ensured by means of the fluid directly surrounding it. As the fluid can evaporate, for example by releasing steam via a corresponding exhaust duct, a maximum temperature of around 100° C. of the energy storage unit is ensured on its surface. Thanks to a cooling device, the potentially chemically contaminated fluid of the interior of the container and/or the mounting does not have to be drained for further cooling. This means that the fluid that is in direct contact with the energy store can be cooled by means of the cooling device.

For example, fluid can be passed through the at least one intermediate space of the double-walled container/the double-walled mounting, allowing this fluid to absorb the heat of the inner, contaminated fluid and thus gradually cool it down. Fluid-conducting pipes in the volume to be cooled or flushing the fluid around the mounting in the inner volume of the container work in a similar way.

Enclosing a hot inner volume with a cooler outer layer has the advantage of simultaneously providing thermal protection for the surroundings. In particular, an intermediate space of a double-walled container and/or a double-walled mounting and/or the inner area of the container in the case of a sealed mounting can be flooded before the area in which the energy store is located.

Since the fluid for cooling is isolated from the contaminated interior in all cases of the proposed cooling device, it can then simply be drained into the sewage system or elsewhere, for example into a body of water. This applies in particular if the fluid is water.

Other forms of cooling devices are also conceivable. For example, Peltier elements and/or heat pumps can be used, or the compressors can be combined with one of the aforementioned solutions.

In a further embodiment, the energy storage unit can be switched off. By switching off the energy storage unit, charging and/or discharging and/or other use of the energy storage unit can be prevented. In particular, at least one switch can be provided that electrically isolates the energy storage device from the devices it supplies. This switch can be positioned both inside and outside the container and/or the mounting. A switch outside has the advantage that the switch is not exposed to any adverse conditions in the interior in the event of a fault. The switch can be, for example, a relay, a triac, a mechanical switch such as a glass barrel, a transistor, a thyristor or another switch. It may be advantageous to be able to control the switch electronically. In this case, the control device can influence the switch. In particular, the control device can switch, especially disconnect, the switch in the event of a detected malfunction of the energy storage device, especially in the event of heating and/or ignition.

The control device can switch off the energy storage device and/or disconnect its electrical connection to other devices. In particular, this switching off and/or disconnection can occur as a function of the measured variables received from the at least one sensor.

In one embodiment, the containment can have several mountings. These can be arranged in several containers or in a single container. A containment can also comprise several containers.

A further embodiment example relates to a vehicle in which a containment is arranged. In particular, this can be a watercraft. In this case, the container can, for example, be formed at least in part by an existing part of the watercraft, such as a storage space. The advantage here is that the fluid supply can be realized as a water supply directly via a pump, which can pump the water on which the watercraft floats into the container. A water pump is often already available on board anyway.

A further embodiment example relates to a building in which the containment in question is arranged. The advantage here is that the weight of the containment is not decisive and, in particular, does not have to be minimized. Therefore, heavy fireproof materials such as a brick room wall with a fireproof door can also form at least parts of the container of the containment.

In one embodiment, the containment can be movable, in particular movable as a whole, in particular portable. For example, the device can be subsequently arranged in buildings and/or vehicles. It is also possible to remove the containment from a building and/or vehicle at a later date. In particular, the containment can be removed from a hazardous environment, such as a building and/or a vehicle, in the event of a fire. For example, the containment can be lowered overboard from a vehicle, in particular a watercraft.

A further aspect of the present solution is the method according to claim 28, which uses a containment of the present invention. An energy storage device is positioned in this containment, in particular in the mounting in the container of the containment. In a second step, fluid is let into the container and/or into the mounting. This can be done via the connection socket and/or the connection duct. The inlet of fluid can be controlled by the control device and started depending on measured values, which are recorded by at least one sensor.

In one embodiment, measured values are monitored by at least one sensor. Based on the measured values, overheating and/or an escape of gases and/or ignition of the energy storage device can be detected. This monitoring and/or detection can be carried out using the control device, for example.

In a further embodiment, the inlet of fluid into the container and/or the mounting is controlled. In particular in the event of detection of overheating and/or ignition of the energy storage device, in particular based on measured values from at least one of the sensors, the inlet of fluid into the container and/or into the mounting can be controlled, in particular started. Fluid can be introduced by means of the control device.

An extinguishing device can also be triggered as an alternative or in addition to the inlet of fluid, for example a fire extinguisher can be activated or the introduction of an inert gas into the container and/or the mounting can be triggered. The extinguishing device can also be triggered by the control device.

In a further embodiment, the container and/or the mounting of the containment can be closed, in particular when overheating and/or ignition of the energy storage device is detected. The control device can control the closing of the container and/or the mounting.

The subject matter is explained in more detail below with reference to a drawing showing embodiments. In the drawing show:

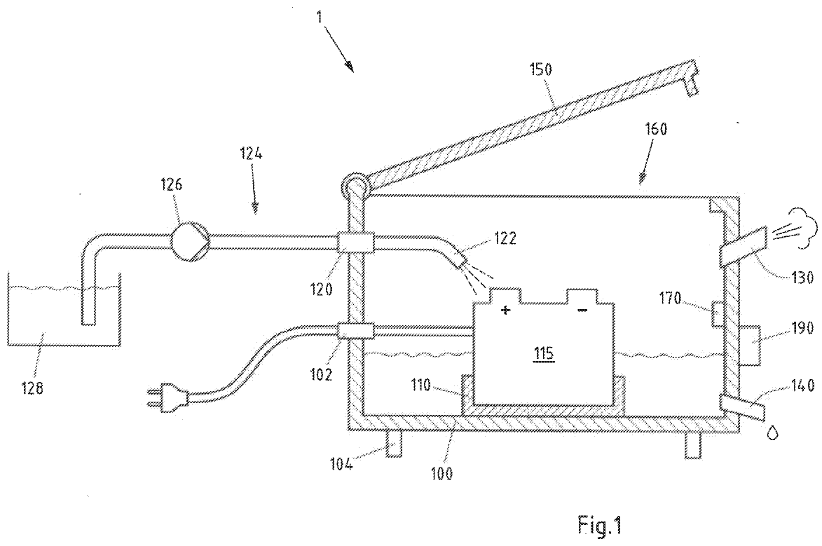

FIG. 1 a containment according to an embodiment;

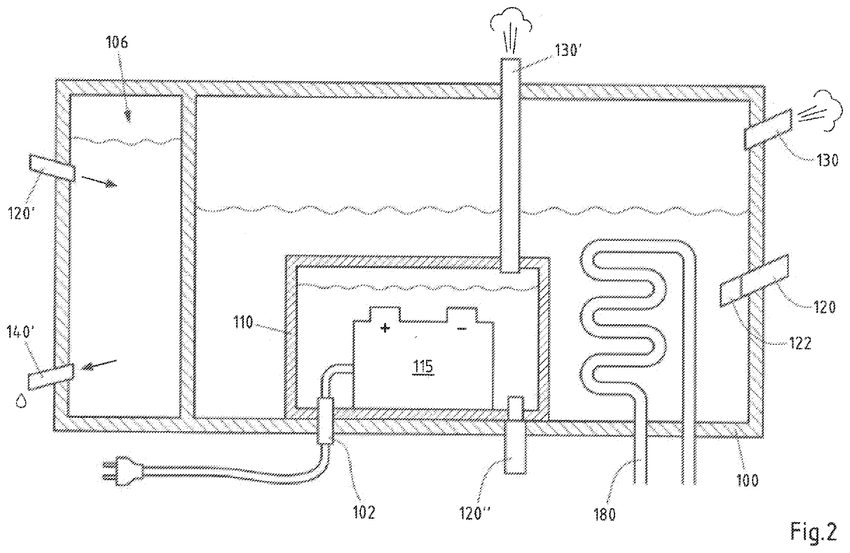

FIG. 2 a containment according to an embodiment;

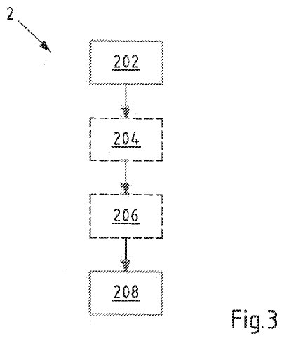

FIG. 3 a method for operating a containment according to an embodiment.

FIG. 1 shows a containment according to the subject matter. This comprises a container 100 with an opening 160. The opening 160 can be closed by a closure 150. In particular, this closure 150 can close the container 100 in a pressure-tight, gas-tight and/or liquid-tight manner. In some embodiments, the closure 150 can be adjusted between open and closed position by a controllable actuator. The container 100 has a connection socket 120 and a connection duct 122, which leads to the mounting 110. Fluid can be fed into the mounting 110 through the connection duct 122. The connection socket 120 is connected to a fluid supply 124, which in the example shown comprises a pump 126 that draws fluid from a reservoir 128. Feet 104 are arranged on the container 100. These can serve to thermally insulate the container 100 and/or to secure it to the surroundings. A drain socket 140 is provided for draining fluid from the container 100. There is also an exhaust duct 130 on the container 100, which can allow heat, steam, smoke and the like to escape from the closed container 100. Furthermore, a cable duct 102 is embedded in the outer wall of the container 100. A cable can be routed through this to the energy storage unit 115, in particular in a pressure-, gas- and/or liquid-tight manner. A sensor 170 can be arranged in the container 100. A control device 190 can also be provided on the container 100. This can evaluate sensor data and actuate actuators.

FIG. 2 shows an example of a containment 1 with a cooling device. In a first embodiment, a double-walled container 100 with an intermediate space 106 is provided for this purpose. The intermediate space 106 has its own connection 120′ and its own outlet 140′. The fluid in the interior of the container 100 can be cooled via the intermediate space 106 without the fluid of the intermediate space 106 being contaminated by a damaged energy store 115. Alternatively or additionally, a cooling device in the form of a cooling line 180 can be provided in the container 100, through which cooling fluid can be passed. The fluid in the container 100 can also be cooled via this. A drain socket for the interior of the container 100 is not necessary; the contaminated fluid remains in the container 100. Also, as also shown in FIG. 2, the mounting can be closed off from the interior of the container 100 so that it can be flooded separately. In addition, the interior of the container 100 can be flooded in order to cool the fluid in the mounting 110 through the wall of the mounting. In this case, a drain 140 as shown in FIG. 1 is again helpful so that the fluid in the interior of the container 100 can be exchanged for an effective action of the cooling device.

FIG. 3 shows an exemplary method for operating a containment 1. In step 202, an energy storage device 115 is inserted into a mounting 110. Step 208 activates the supply of fluid via the connection socket 120. Step 208 can be preceded by monitoring of measurement data in step 204, which is recorded by sensors 170. In this way, overheating and/or a fire can be detected in step 206, in particular by means of the control device 190, based on the sensor data. The activation of the flooding of the container 100 after step 208 can thus be made dependent on the detection of a malfunction based on sensor data.

1-32. (canceled)

33. Containment for an energy storage device comprising:
a sealable container with a mounting for the energy storage device;
a connection duct with a connection socket, leading into the mounting; and
an exhaust socket interconnected with the mounting.

34. Containment of claim 33, wherein
the connection socket is connectable to a fluid supply in a fluid-tight manner.

35. Containment of claim 33, wherein
the exhaust socket is arranged on an outer wall of the container, in particular in that the exhaust socket is connected to an exhaust duct.

36. Containment of claim 33, wherein
the connection duct is led from an outer wall of the container into the mounting.

37. Containment of claim 33, wherein
the closure seals the exhaust socket from the mounting in a fluid-tight manner, in particular wherein the closure can be opened as a function of a pressure in the mounting and/or a temperature, wherein the closure is in particular a rupture disk.

38. Containment of claim 33, wherein
the exhaust socket is made of a heat-resistant and/or fireproof material.

39. Containment of claim 33, wherein
a cable entry is led from the outer wall of the container into the mounting, in particular the cable entry being fireproof and/or pressure-resistant and/or fluid-tight.

40. Containment of claim 33, wherein
an energy storage device is arranged within the mounting, in particular an electrical energy storage device, in particular a chemical storage device, in particular an accumulator, in particular a lithium-ion accumulator.

41. Containment of claim 33, wherein
the at least one inner wall of the mounting and/or the walls of the container are at least partially formed from a fireproof material, in particular wherein the fireproof material is at least partially formed from metal and/or fireproof plastic and/or ceramic and/or a mineral building material, in particular concrete or stone and/or as masonry.

42. Containment of claim 33, wherein
the mounting and/or the container can be sealed in a pressure-resistant manner.

43. Containment of claim 33, wherein
a discharge duct with a discharge socket is guided from the mounting to the outer wall of the container.

44. Containment of claim 43, wherein
the discharge socket is arranged in the lower region of the container and/or the mounting and/or the connection socket is arranged in the upper region of the container and/or the mounting.

45. Containment of claim 33, wherein
a distribution means in the container and/or the mounting is in fluid connection with the connection duct, and the distribution means has two outlets within the container and/or the mounting which are spatially spaced apart from one another.

46. Containment of claim 43, wherein
the connection socket and/or the discharge socket and/or the exhaust socket is arranged on the container and/or the mounting in such a way that it cannot be lost.

47. Containment of claim 33, wherein
the connection socket is coupled to a pump, in particular a motor-driven and/or manual pump, and/or a water supply connection, in particular of a building.

48. Containment of claim 33, wherein
at least one extinguishing device is arranged in and/or on the container, in particular a powder fire extinguisher, foam fire extinguisher, CO₂ fire extinguisher, a supply of an inert gas, in particular nitrogen, CO₂ and/or another extinguishing gas, in particular a controllable extinguishing device.

49. Containment of claim 33, wherein
at least one sensor is arranged in and/or on the container and/or the mounting, in particular a temperature sensor, pressure sensor, filling level sensor, humidity sensor, optical sensor, gas sensor, pH sensor, sound sensor and/or acceleration sensor.

50. Containment of claim 33, further comprising
at least one display means, in particular a light source, a screen, an indicator paint, a pressure pen and/or an acoustic display means, the display means being arranged in particular on the container.

51. Containment of claim 33, further comprising
a control device, in particular an electronic circuit and/or a digital circuit, in particular a processor.

52. Containment of claim 49, further comprising
a control device set up to receive measured variables detected by at least one of the sensors and/or to control at least one actuator of the containment, in particular as a function of the detected measured variables.

53. Containment of claim 52, further comprising
a discharge duct, with a discharge socket, guided from the mounting to the outer wall of the container and wherein
the connection socket and/or the discharge socket and/or a water supply connection can be controlled, in particular as a function of a measured value detected by one and/or more of the sensors, in particular of a water level and/or a temperature of the water in the container and/or the mounting, in particular by means of the control device.

54. Containment of claim 51, wherein
the container and/or the mounting can be opened and/or closed, in particular can be reconfigured from an open state to a closed state, in particular by means of an actuator, in particular by means of a motor, in particular an actuator controlled by the control device.

55. Containment of claim 33, further comprising
a cooling device arranged to cool the fluid in the container and/or in the mounting,
in particular the cooling device comprises parts of the wall of the container and/or in the mounting, wherein the container and/or the mounting is at least partially double-walled with an inner and an outer wall, in particular that at least one further connection duct leads from an outer wall of the container into the intermediate space between an inner and an outer wall and a further discharge duct leads from the intermediate space to the outer wall of the container, and/or
the cooling device has a cooling element in the interior of the container and/or in the mounting, through which cooling means, in particular water, can be guided and/or
the cooling device comprises the interior of the container, the mounting being sealed in a fluid-tight manner with respect to the interior of the container, so that water in the interior of the container can cool the water in the mounting through the wall of the mounting, and/or
the cooling device comprises a heat pump and/or a peltier element.

56. Containment of claim 52, wherein
the control device is set up to switch off the energy storage device, in particular as a function of measured variables detected by means of the sensors, in particular by means of a switch, which is arranged in particular outside the container.

57. Containment of claim 33, further comprising several mountings, which are arranged in particular in a container.

58. Vehicle, in particular watercraft, with a containment of claim 33.

59. Building with a containment of claim 33.

60. Method for discharging an energy storage device using a containment of claim 52, in which
an energy storage device is positioned in the mounting of the containment, and
fluid is fed through the connection socket and connection duct into the container and/or into the mounting.

61. Method of claim 60, wherein
the measured values are monitored by at least one sensor and overheating and/or ignition of the energy store is detected as a function of the measured values.

62. Method of claim 60, wherein
the fluid is fed through the connection socket and connection duct into the container and/or into the mounting as a function of one of the measured values.

63. Method of claim 60, wherein
the container and/or the mounting is sealed as a function of one of the measured values.

64. Method of claim 62, wherein
the fluid in the container and/or the mounting is cooled, in particular by means of a cooling device.
